(19) United States
(12) Patent Application Publication
(10) Pub. No.: US 2008/0134077 A1
(43) Pub. Date: Jun. 5, 2008

(54) Chameleon graphic user interface

(75) Inventors: Bavi Cheng, Shanghai (CN); Bing Liang, Shanghai (CN)

Correspondence Address: SAP/BLAKELY, 1279 OAKMEAD PARKWAY, SUNNYVALE, CA, 94085-4040, US

(73) Assignee: SAP AG

(21) Appl. No.: 11/634,443

(22) Filed: Dec. 5, 2006

(51) Int. Cl. G06F 3/048

(52) U.S. Cl. 715/781

(57) ABSTRACT

A Chameleon graphical user interface (GUI) is adaptive to a display environment of a requesting application. In one embodiment, a process includes, but is not limited to, receiving a request from a requesting application, the request indicating a display environment of the requesting application; in response to the request, receiving a document from a system hosting the document, the document having a first display; and transforming the document from the first display style to a second display style, the second display style being associated with the display environment of the requesting application.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to a graphical user interface (GUI). More particularly, this invention relates to a GUI adapted to a display environment that requests the Web page.

### BACKGROUND

Conventional graphical user interfaces (GUI) allow a user to request and display a document presentation (e.g., a Web page) that has a display style inconsistent with the style of the GUI. For example, FIG. 1 shows a GUI 80 of application software 20 that displays a tool bar 12 on the top and a main menu 10 on the left-hand side. Main menu 10 includes one or more items, which, when selected, invoke a browser to display a Hypertext Markup Language (HTML) document. This browser is typically the default browser of the computer that runs GUI 80. In the example as shown, the default browser is the Internet Explorer® (IE), a product of Microsoft Corporation in Redmond, Wash.

Thus, when a user clicks on one of the menu items, e.g., EU Tax Declaration 25, application software 20 invokes an IE browser to display the Web page that contains the requested information. An IE window 30 is then popped up on GUI 80 to display the requested Web page. IE window 30 has a different display style from the display style of application software 20. For example, IE window 30 has a frame 33, a tool bar 31, and address editor space 32, all of which are in a typical IE style. IE window 30 also has a button 35 which may operate differently from buttons 16 provided by application software 20. The background color of IE window 30 is different from the background color of displayed application software 20. These inconsistencies in the display styles may sometimes cause confusions and reduce work productivity. For example, a user may confuse tool bar 31 in IE window 30 with tool bar 12 of application software 20. A user may also expect button 35 in IE window 30 to operate in the same way as buttons 16 of application software 20.

### SUMMARY OF THE DESCRIPTION

A Chameleon graphical user interface (GUI) is adaptive to a display environment of a requesting application. In one embodiment, a process includes, but is not limited to, receiving a request from a requesting application, the request indicating a display environment of the requesting application; in response to the request, receiving a document from a system hosting the document, the document having a first display; and transforming the document from the first display style to a second display style, the second display style being associated with the display environment of the requesting application.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a diagram illustrating a prior art graphical user interface (GUI), in which application software and a Web page are displayed in two different styles.

FIGS. 2A-2B are block diagrams illustrating certain embodiments of a system that supports a Chameleon GUI.

FIG. 3 is a block diagram illustrating an embodiment of the components in the Chameleon GUI platform.

FIGS. 4A-4B are diagrams illustrating examples of the Chameleon GUI displaying application software and a Web page in the same style according to one embodiment.

FIGS. 5A-5B are diagrams illustrating examples of a system and process for generating an adaptive component of the Chameleon GUI according to one embodiment.

FIGS. 6A-6C are diagrams illustrating operations performed by the Chameleon GUI and the component definitions used by the Chameleon GUI according to one embodiment.

FIG. 7 is a flowchart illustrating an embodiment of a process performed by the components of the Chameleon GUI.

FIG. 8 is a block diagram illustrating a data processing system that may be used as an embodiment of the invention.

### DETAILED DESCRIPTION

A Chameleon graphic user interface (GUI) is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

A Chameleon GUI (also referred to as an adaptive GUI) adapts a document page to a display environment from which the document page is requested and presented. Note that throughout this application, a Web page is used as an example of a document presentation. But is not so limited; other document presentations (e.g., slides or other GUI applications) may also be applied. The presentation of the Web page is in a style consistent with the style of the display environment. The term “Chameleon” is used herein to analogize the GUI to a chameleon which automatically changes its appearance (e.g., color or style) to match the background environment. Through the Chameleon GUI, the same Web page can be displayed in different styles when the Web page is requested by different display environments. The term “display environment” herein refers to the environment that displays the application software requesting the Web page. For example, SAP Business One, which is a product of SAP AG located in Germany, may be displayed by an SAP system, a Windows® system, or a Macintosh® system. The same application software may have different appearances when running in different display environments. Regardless in which display environment the application software runs, the Chameleon GUI ensures that the application software and the Web pages requested by the application software are displayed in the same style.

Some application software, e.g., SAP Business One, provides a user a variety of options to request and display a Web page on the GUI. For example, an option may be to invoke a Web page that calculates a tax due. The Web page is typically coded in a hypertext markup language (HTML) document that includes textual contents and definitions of a display style. The display style defined in the HTML document may be inconsistent with the display environment of the application software. Moreover, the GUI may use a default browser window to display the HTML document. The setting of the default browser window may also be inconsistent with the display environment of the application software. The Chameleon GUI detects and changes these inconsistencies in the display style of HTML documents and the browser settings. Thus, information displayed on the Chameleon GUI has a consistent appearance. Further, display objects in the Web page can be operated in a manner consistent with the corresponding display objects in the application software. The term “display object” used herein refers to a graphical component in the display that reacts to a user's action. A display object includes, but is not limited to, a dropdown list, a button, a selectable link, and a textual editor. It is understood that the Chameleon GUI is not limited to an enterprise environment. It will be appreciated that other proprietary or non-proprietary application software may also benefit from using the Chameleon GUI.

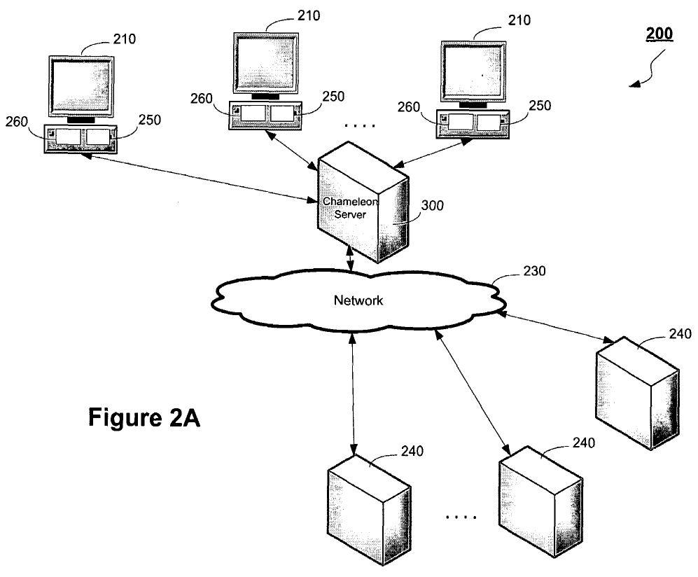

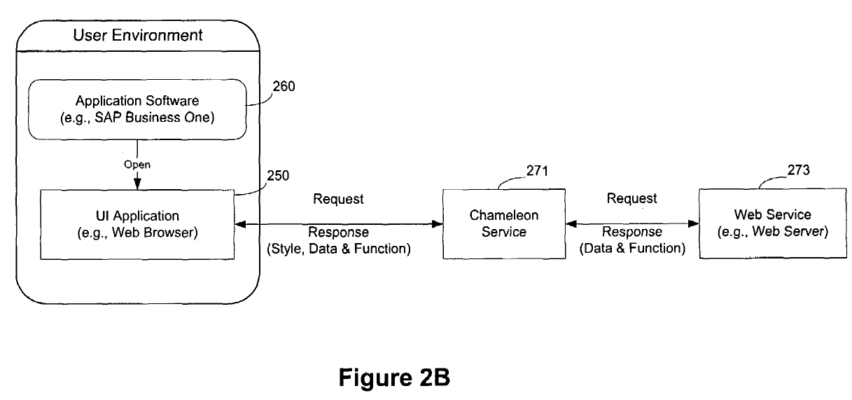

FIG. 2A is a block diagram illustrating a system having a Chameleon GUI according to one embodiment of the invention. Referring to FIG. 2A, system 200 includes one or more client units 210 which operate UI application 250 and application software 260. The term “client unit” herein refers to a processing unit from which requests for Web pages are submitted. Client unit 210 is a “client” in a relative sense to a server that hosts the requested Web page. However, it is understood that client unit 210 may be a host to other processing units or systems that request its services. System 200 also includes a Chameleon server 300 and a network 230 through which client units 210 communicate with each other and with one or more Web servers 240. Network 230 may be a local area network, the Internet, an enterprise intranet, any combination of the above networks, or any suitable networks. Web servers 240 may be publicly accessible or proprietarily owned. Web servers 240 host a plurality of Web pages which are coded in a language (e.g., HTML) that can be displayed by a Web browser. In the discussions that follow, a “Web page” is used synonymously with a “document.” Examples of a Web browser include, but are not limited to, Internet Explorer®, Safari®, Firefox®, Netscape®, and any suitable proprietary or non-proprietary browsers that can display the contents and render the graphics of Web pages. The components of system 200 are shown for illustration purposes only and other configurations may exist.

Client unit 210 executes application software 260 which interacts with its user through UI application 250. Through UI application 250, a user of application software 260 may select options from a menu to view Web pages and to perform tasks predefined in the Web pages. UI application 250 presents information in a consistent style so that Web pages provided by different sources are integrated into the display environment of application software 260.

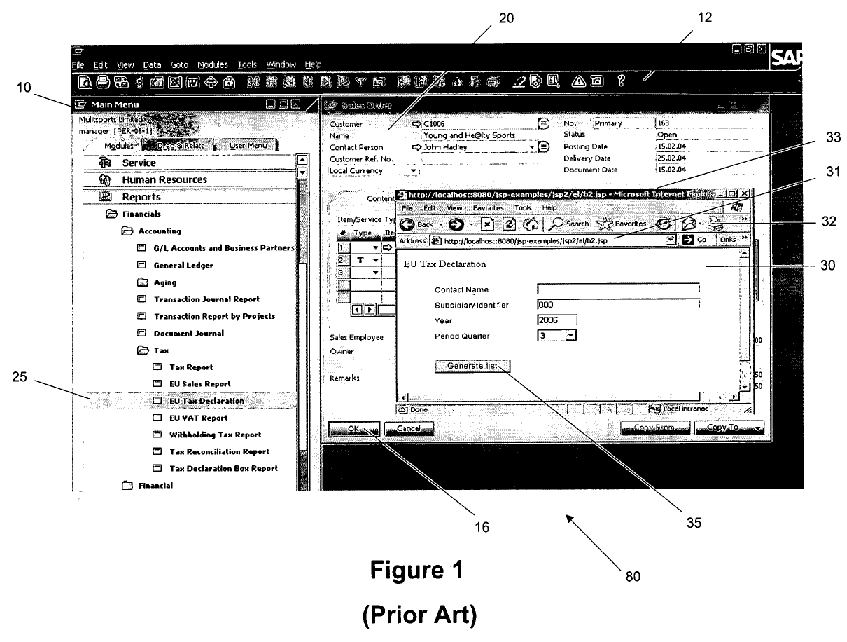

FIG. 2B is a block diagram illustrating a system configuration according to an alternative embodiment of the invention. Referring to FIG. 2B, in this example, UI application 250, such as a browser application, communicatively coupled to a Chameleon service 271. Chameleon service 271 forwards user requests to a Web service 273 (e.g., a web service provided by Web server 240 of FIG. 1), and forwards the response from the web service to UI application 250. In one scenario, the response from Web service 273 includes data and function related to displaying the data. Chameleon service 271 transforms the style in the data and function according to the user environment specified in the user requests. Chameleon service 271 may be implemented as a standalone application hosted by a standalone server (e.g., Chameleon server 300 of FIG. 1) or any computing platform. Alternatively, Chameleon service 271 may be implemented as part of UI application 250, a plug-in with respect to UI application 250, or as part of Web service 273.

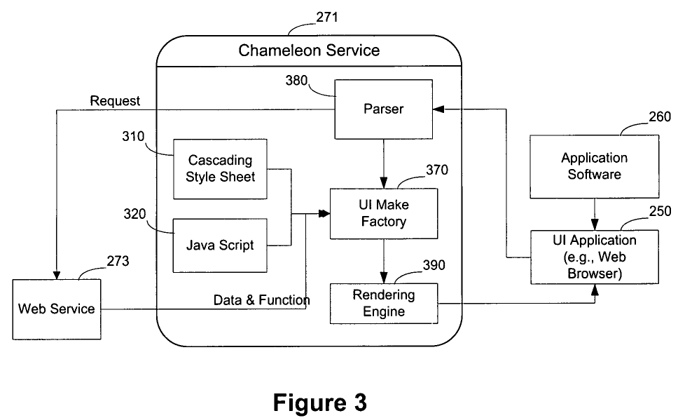

FIG. 3 illustrates an embodiment of a Chameleon service 271 of FIG. 2. Chameleon service 271, according to one embodiment, includes a parser 380, a UI Make Factory 370, and a rendering engine 390. UI Make Factory 370 is also referred to as a transformation unit. Parser 380 receives a request for a document submitted from UI application 250. The request specifies the display environment of application software 260 and an address (e.g., a universal resource locator (URL)) of the requested document. From the display environment specified in the request, parser 380 determines the display style to be used for displaying the requested document. Parser 380 retains the information about the display environment and, according to the address, forwards the rest of the request to a system (e.g., Web service 273) that hosts the requested document. When the requested document arrives at client unit 210, parser 380 parses the requested document to identify keywords (e.g., HTML tags or other standard identifiers) associated with the display style of the document. After some or all the keywords associated with the display style are identified in the requested document, UI Make Factory 370 transforms the display style of the requested document into the display style that matches or corresponds to the display environment of application software 260. For example, a user who selects an option from an SAP system to request a Web page will see the Web page displayed in the SAP display style, regardless the source of the Web page and the style definitions included in the Web page. Note that some of all of the components as shown in FIG. 3 may be implemented in software, hardware, or a combination of both.

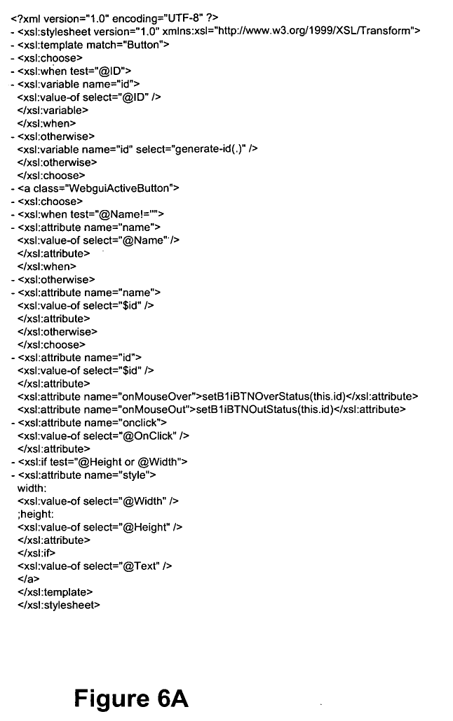

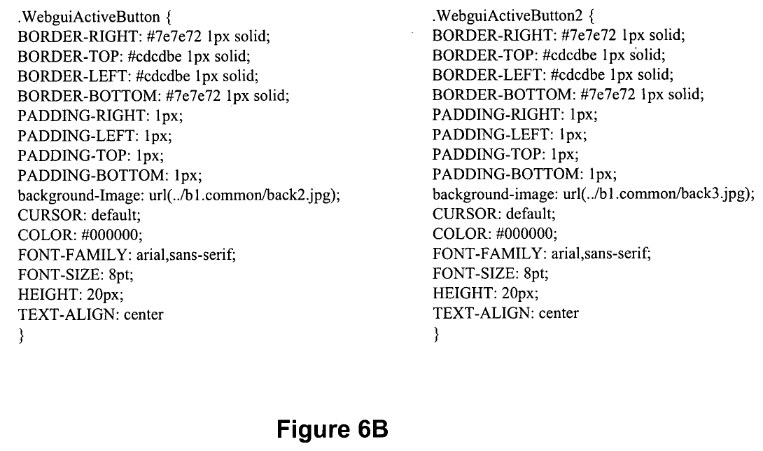

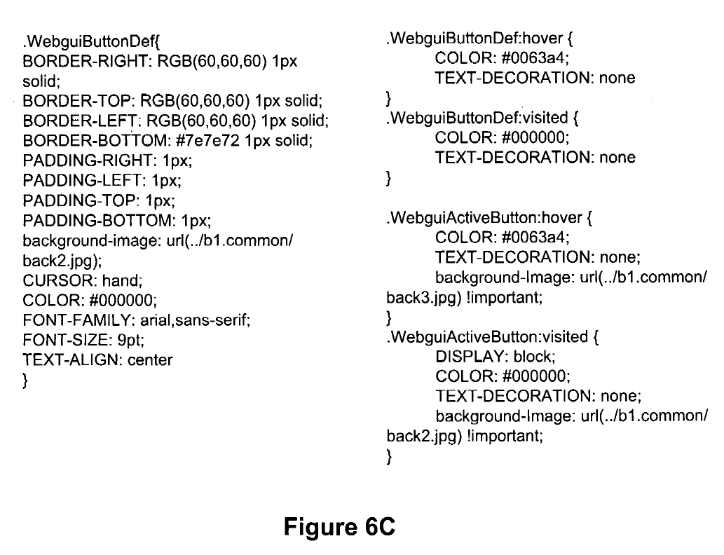

UI Make Factory 370 replaces definitions of the identified keywords with definitions of corresponding keywords associated with a display style that matches the display environment of application software 260. An example of transformations performed by UI Make Factory 370 is shown in FIGS. 6A. The transformations in this example are designed or configured in XML (extensible markup language); other programming languages may also be used. UI Make Factory 370 performs the transformations by referring to, for example, a Cascading Style Sheet (CSS) 310 and/or a Java script 320. CSS 310 includes the definitions of a plurality of display styles for a plurality of display environments. An example of a CSS that defines different styles of a button is shown in FIGS. 6B-6C. For each display environment, CSS 310 defines the static appearances of documents and Java script 320 defines the actions performed by display objects in response to user interaction such as a cursor movement. The static appearance includes, but is not limited to, a color for the background, a font and a font size for the text, a position for a dropdown list, a shape, a size, and a color for the buttons, as well as other designs and layout of display objects. The actions performed by the display objects in response to user interaction (e.g., a cursor movement) include, but are not limited to, changing the color of a button when the cursor is placed on the button, and highlighting the space in a text editor when the cursor is placed in the text editor. A cursor movement may be caused by a mouse, a keyboard, a stylus, or other suitable means.

According to one embodiment, UI Make Factory 370 may be used to generate different components that make up a document page (e.g., a Web page), such as, for example, a button, a menu, or a dialog box, etc. These makeup components may be designed or configured using a variety of programming languages, such as, for example, HTML or XML (extensible markup language).

After the transformation, according to one embodiment, rendering engine 390 processes the requested document for display. Rendering engine 390 invokes a default browser of UI application 250 to render graphics and to display the textual contents of the requested document. If the requested document includes Java code, the default browser invokes a virtual machine to execute the Java code for display.

Rendering engine 390 ensures that the setting of the browser window that displays the requested document matches the setting of the display environment of application software 260. The setting includes a frame style and functions associated with the frame style. The functions associated with the frame style include, but are not limited to, a tool bar, an address editor, and a scroll bar. For example, application software 260 may be displayed in an SAP environment but the default browser may be the Internet Explorer® (IE). The frame style of the SAP environment and that of the IE are different. For example, an IE window generally has a frame including the text “Microsoft Internet Explorer” prominently shown on the top margin of the frame. Rendering engine 390 can change the frame style and other settings that come with the browser. The setting can be changed by altering the setting of the default browser window, or by creating a second browser window having the setting that matches the SAP display environment.

Some application software has a built-in mechanism to create a form, that is, a mechanism to invoke a Web browser. If application software 260 has this mechanism, application software 260 creates a form and embeds a default browser window in the form. The default browser window is used for displaying the requested document on a GUI. Rendering engine 390 then overwrites the setting of the default browser window with another setting that matches the display environment of application software 260. This change of setting does not affect other instances of browser windows but merely affects the browser window in which the requested document is displayed.

If application software 260 does not have the mechanism to create a form, rendering engine 390 instead creates a default browser window on the GUI. A Java script in the default browser window is executed to create a second browser window on the GUI for displaying the requested document. The second browser window has a setting that matches the display environment of application software 260. Thereafter, rendering engine 390 closes the default browser window. Although the default browser window and the second browser window are two different instances of the same default browser, the setting of the second browser window is changed to match the display environment of application software 260. This change of setting does not affect other instances of browser windows but merely affects the second browser window in which the requested document is displayed. The default browser window can be designed such that it is closed before perceived by a human eye. Thus, a user of application software 260 sees only the second browser window having a setting consistent with the display environment of application software 260.

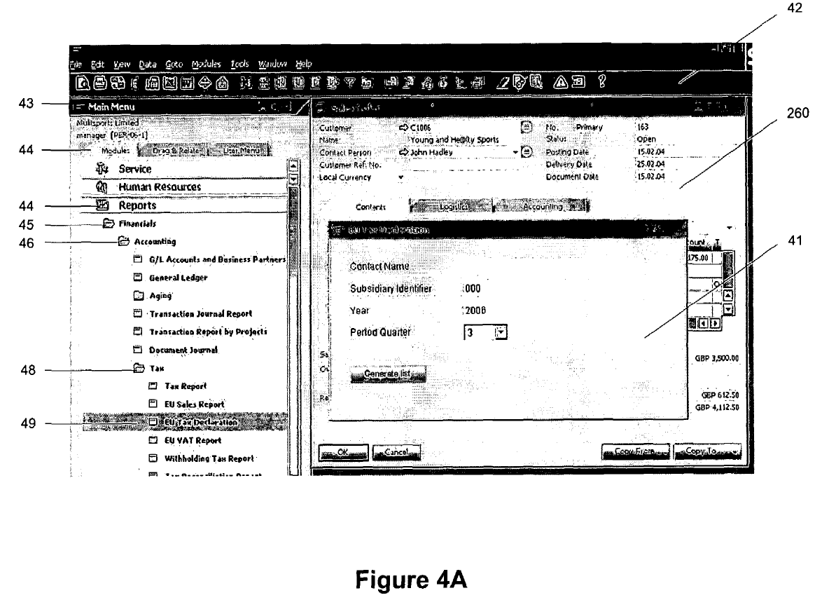

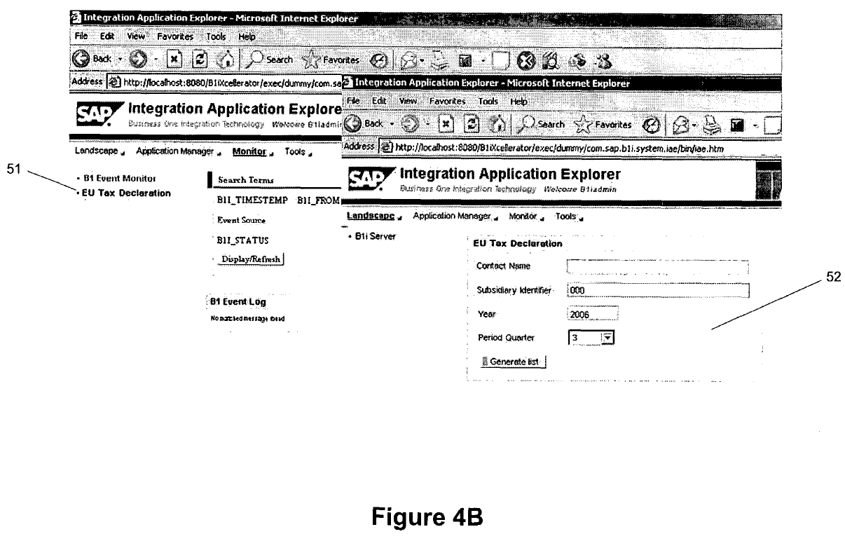

FIG. 4A shows an example of a GUI having an adaptive feature according to one embodiment of the invention. In the background is a graphical display of an embodiment of application software 260 of FIGS. 2A-2B and FIG. 3. A tool bar 42 is shown on the top and a main menu 43 is shown on the left-hand side. Main menu 43 includes a selection of options offered by application software 260. Main menu 43 is organized to include one or more tabs, one or more folders, and one or more sub-folders. In the embodiment as shown, a “modules” tab 44 is selected. Under modules tab 44, a reports folder 45 is selected. Under reports folder 45, a financials sub-folder 46, an accounting sub-folder 47, and a tax sub-folder 48 are successively selected in that order. The bottommost sub-folder, i.e., tax sub-folder 48, includes a plurality of selectable items, each of which when selected causes a Web page to be displayed. For example, a user may select an item “EU Tax Declaration” 49 under tax sub-folder 48 by clicking on the item. The click causes a request to be sent from UI application 250. The request includes the address of Web page 41 and a parameter that indicates the type of the display environment. In the example as shown, the display environment is the SAP environment in which application software 260 is displayed. Thus, requested Web page 41 and application software 260 will be displayed together in a specific operating environment such as an SAP environment. Again, these graphical components are shown for illustration purposes only and other designs and layout may exist.

After the user clicks on item “EU Tax Declaration” 49, Web page 41 pops up on the GUI. Web page 41 has the same display style as application software 260. To a user, Web page 41 appears to be an integral part of application software 260. A user would not know, from the appearance of the Web page, that Web page 41 is actually displayed by a default browser, e.g., the Internet Explorer®. The textual contents and the functionality of Web page 41 are the same as the Web page before the transformation. The change of display style and the setting merely affect the appearance of Web page 41. However, the consistency in the appearance between application software 260 and Web page 41 greatly increases user-friendliness of the application software. For example, a user can operate buttons or controls in application software 260 and Web page 41 in a similar manner and will see the buttons reacting to cursor movements in the same way.

FIG. 4B is another example of a GUI having an adaptive feature according to one embodiment of the invention. In this example, it is in a Windows® environment. When application software 260 is executed in the Windows® environment, the requested Web page will also be shown in the Windows® style. In the example as shown, when a user clicks on an item “EU Tax Declaration” 51 on the left-hand side of the display, a request for a Web page 52 is submitted to a Web server. The request specifies the address of Web page 52 and identifies the Windows® as the display environment. As a result, Web page 52 is displayed in the Windows® style, consistent with the display style of application software 260. Again, these graphical components are shown for illustration purposes only and other designs and layouts may exist.

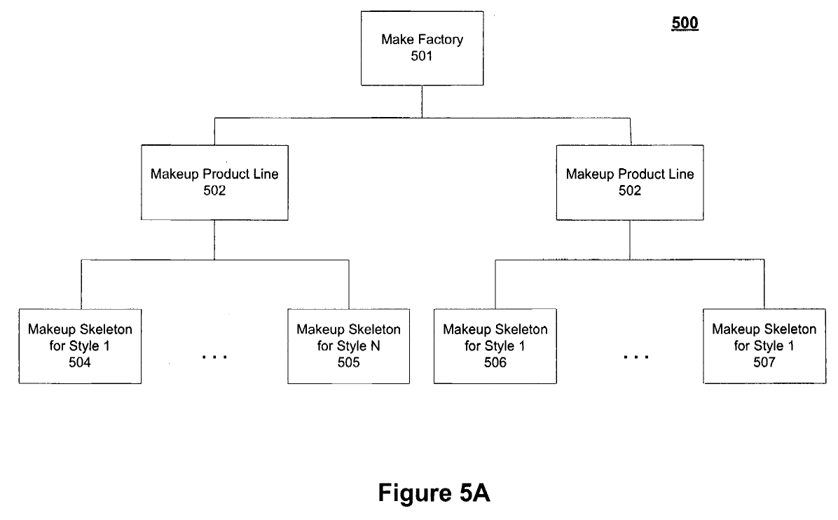

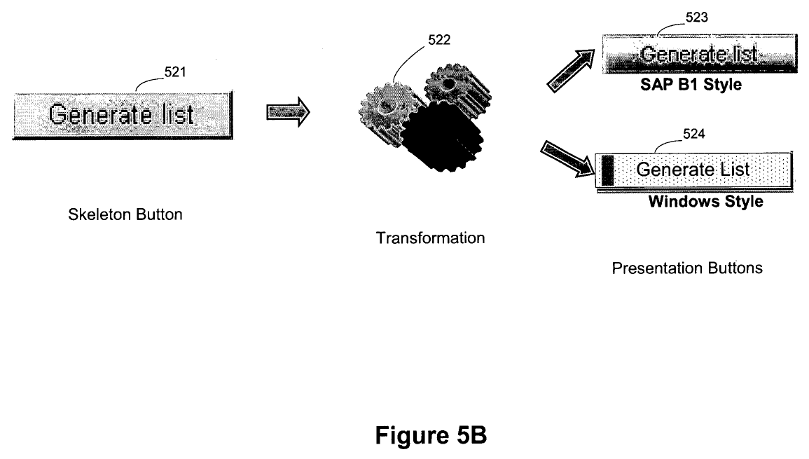

FIGS. 5A and 5B are diagrams illustrating examples of a system and process for generating an adaptive component of an adaptive GUI according to one embodiment. For example, operations involved in FIGS. 5A and 5B may be performed by UI Make Factory 370 of FIG. 3, which may be implemented in software, hardware, or a combination of both. Referring to FIG. 5A, a Make Factory 501 includes one or more makeup product lines 502-503, each having one or more make skeletons 504-507 for different styles. Makeup product lines 502-503 are configured to generate (e.g., make up) skeletons for different styles according to different operating environments. Product lines 503-504 may be added and maintained by Make Factory 501 dependent upon a variety of operating environments

In one embodiment, referring to FIGS. 5A and 5B, each of the makeup product lines 502-503 is configured to define new components styles, which may be represented via certain languages such as HTML or XML, as shown in FIGS. 6B and 6C, and to transform skeleton components (e.g., component 521) to new components (e.g., components 523) via a makeup process 522. A product line may scan and make up most or all skeleton components, such as, for example, labels, buttons, fonts, dropdown menu, checkbox, form, etc. For example, during making up a button, processing logic may separate a page style (e.g., makeup button) and page content (e.g., skeleton button), for example, using a CSS file. Processing logic further defines a makeup button to simulate a new environment, including, for example, color, border, font size, font type, width, height, and/or animation, etc.

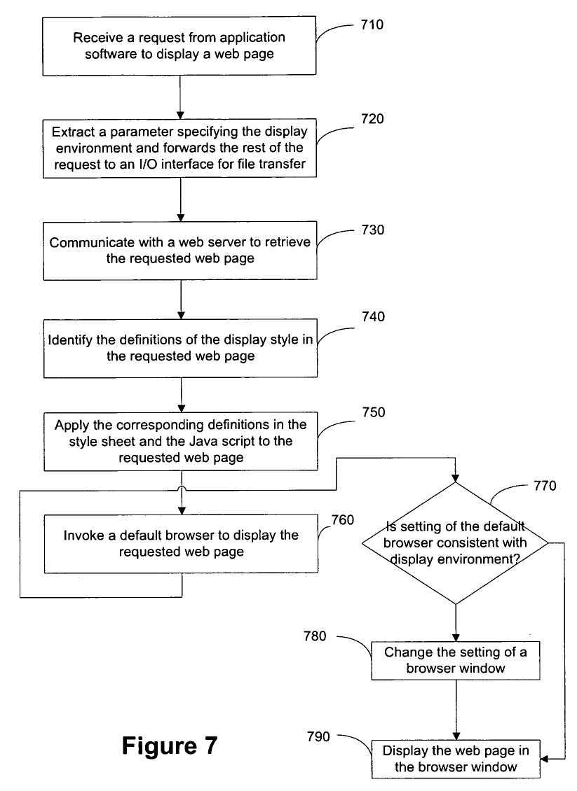

FIG. 7 is a flow diagram illustrating a process for an adaptive GUI according to an embodiment of the invention. Note that process of FIG. 7 may be performed by processing logic which may include software, hardware, or a combination of both. For example, process as shown in FIG. 7 may be performed by systems of FIGS. 2A-2C and FIG. 3. Referring to FIGS. 3 and FIG. 7, at block 710, Chameleon server 300 (of FIG. 2A) receives a request from application software to display a Web page corresponding to a selected item. The request is in the form of an address and a parameter that specifies the requester's display environment. At block 720, parser 380 extracts the parameter specifying the display environment and forwards the rest of the request to an I/O interface that performs file transfer. At block 730, the I/O interface communicates with a Web server to retrieve the requested Web page according to the address. At block 740, parser 380 identifies the definitions of the display style in the requested Web page. At block 750, UI Make Factory 370 applies the corresponding definitions in CSS 310 and Java script 320 to the Web page. The definitions in CSS 310 and Java script 320 overwrite the styles defined in the Web page. At block 760, rendering engine 390 invokes a default browser to display the transformed Web page. At block 770, rendering engine 390 determines whether the setting of default browser is consistent with the display environment. If it is inconsistent, at block 780, rendering engine 390 changes the setting of a browser window. At block 790, the Web page is then displayed in the browser window that has a display setting matching the setting of the display environment. Other operations may also be performed.

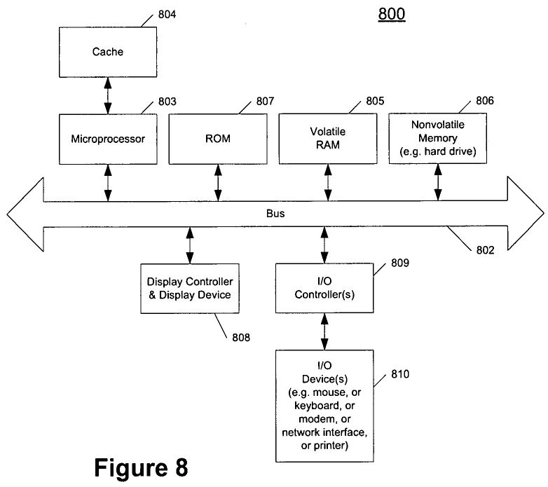

FIG. 8 is a block diagram of a digital processing system, which may be used with one embodiment of the invention. For example, the system 800 shown in FIG. 8 may be used as a client and/or a server as described above with respect to FIGS. 2A-2C and FIG. 3.

Note that while FIG. 8 illustrates various components of a computer system, it is not intended to represent any particular architecture or manner of interconnecting the components, as such details are not germane to the present invention. It will also be appreciated that network computers, handheld computers, cell phones and other data processing systems which have fewer components or perhaps more components may also be used with the present invention.

As shown in FIG. 8, the system 800, which is a form of a data processing system, includes a bus or interconnect 802 which is coupled to one or more microprocessors 803 and a ROM 807, a volatile RAM 805, and a non-volatile memory 806. The microprocessor 803, which may be, for example, a PowerPC processor or an Intel Pentium processor, is coupled to cache memory 804 as shown in the example of FIG. 8. The bus 802 interconnects these various components together and also interconnects these components 803, 807, 805, and 806 to a display controller and display device 808, as well as to input/output (I/O) devices 810, which may be mice, keyboards, modems, network interfaces, printers, and other devices which are well-known in the art.

Typically, the input/output devices 810 are coupled to the system through input/output controllers 809. The volatile RAM 805 is typically implemented as dynamic RAM (DRAM) which requires power continuously in order to refresh or maintain the data in the memory. The non-volatile memory 806 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 8 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 802 may include one or more buses connected to each other through various bridges, controllers, and/or adapters, as are well-known in the art. In one embodiment, the I/O controller 809 includes a USB (Universal Serial Bus) adapter for controlling USB peripherals. Alternatively, I/O controller 809 may include an IEEE-1394 adapter, also known as FireWire adapter, for controlling FireWire devices.

Thus, a Chameleon GUI has been described herein. Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, ABAP, Fortran, Pascal, Perl, etc.) supported by various software development frameworks (e.g., Microsoft Corporation's NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for a graphic user interface (GUI), the method comprising:
receiving a request from a requesting application, the request indicating a display environment of the requesting application;
in response to the request, receiving a document from a system hosting the document, the document having a first display; and
transforming the document from the first display style to a second display style, the second display style being associated with the display environment of the requesting application.

2. The method of claim 1 further comprising:
parsing the requested document to identify keywords associated with the first display style; and
replacing definitions of the keywords with definitions of corresponding keywords associated with the second display style.

3. The method of claim 1 further comprising:
embedding a default browser window in a form by the requesting application for displaying the requested document on the GUI; and
overwriting a first setting of the default browser window with a second setting, the second setting corresponding to the display environment of the requesting application.

4. The method of claim 1 further comprising:
creating a default browser window on the GUI, the default browser window having a first setting; and
executing a script in the default browser window to create a second browser window on the GUI for displaying the requested document, the second browser window having a second setting that corresponds to the display environment of the requesting application.

5. The method of claim 4, wherein the second setting includes a frame style of the second browser window.

6. The method of claim 1 wherein the requested document is a hypertext markup language (HTML) compatible document.

7. The method of claim 1 further comprising:
replacing a first display object having the first display style with a second display object having the second display style, the second display object reacting to a cursor movement differently from the first display object.

8. The method of claim 1 further comprising:
defining the second display style in a style sheet, the style sheet including definitions of a static appearance of the requested document.

9. The method of claim 1 further comprising:
defining the second display style in a script, the script including definitions of actions performed by display objects in the requested document in response to cursor movements.

10. A graphical user interface (GUI) platform comprising:
a parser to receive a request from a requesting application, the request indicating a display environment of the requesting application; and
a transformation unit coupled to the parser to transform a first display style of a requested document into a second display style, the second display style being associated with the display environment of the requesting application.

11. The GUI platform of claim 10 further comprising a rendering engine to render a default browser window in a form created by the requesting application, the rendering engine overwriting a first setting of the default browser window with a second setting corresponding to the display environment of the requesting application, wherein the default browser window is for displaying the requested document on the GUI.

12. The GUI platform of claim 10 further comprising:
a rendering engine, which:
creates a default browser window on the GUI, the default browser window having a first setting;
executes a script in the default browser window to create a second browser window on the GUI for displaying the requested document, the second browser window having a second setting that matches the display environment of the requesting application.

13. The GUI platform of claim 12, wherein the second setting includes a frame style of the second browser window.

14. The GUI platform of claim 10, wherein the request is in a style sheet, including definitions of a static appearance of the requested document.

15. The GUI platform of claim 10 further comprising a script, the script including definitions of actions performed by display objects in the requested document in response to cursor movements.

16. A machine-readable medium having instructions, when executed, cause a machine to perform a method, the method comprising:
receiving a request from a requesting application, the request indicating a display environment of the requesting application;
in response to the request, receiving a document from a system hosting the document, the document having a first display; and
transforming the document from the first display style to a second display style, the second display style being associated with the display environment of the requesting application.

17. The machine-readable medium of claim 16, wherein the method further comprising:
parsing the requested document to identify keywords associated with the first display style; and
replacing definitions of the keywords with definitions of corresponding keywords associated with the second display style.

18. The machine-readable medium of claim 16, wherein the method further comprising:
embedding a default browser window in a form by the requesting application for displaying the requested document on the GUI; and
overwriting a first setting of the default browser window with a second setting, the second setting corresponding to the display environment of the requesting application.

19. The machine-readable medium of claim 18, wherein the method further comprising:
creating a default browser window on the GUI, the default browser window having a first setting; and
executing a script in the default browser window to create a second browser window on the GUI for displaying the requested document, the second browser window having a second setting that corresponds to the display environment of the requesting application.

20. The machine-readable medium of claim 19, wherein the second setting includes a frame style of the second browser window.
